(19) United States
(12) Patent Application Publication
(10) Pub. No.: US 2002/0075965 A1
(43) Pub. Date: Jun. 20, 2002

(54) Digital signal processing techniques for improving audio clarity and intelligibility

(75) Inventors: Leif Claesson, Berkeley, CA (US); Keith McMillen, Berkeley, CA (US); Richard Hodges, Oakland, CA (US); Timothy J. Carroll, San Bruno, CA (US)

Correspondence Address: BEYER WEAVER & THOMAS LLP, P.O. BOX 778, BERKELEY, CA, 94704-0778, US

(73) Assignee: Octiv, Inc.

(21) Appl. No.: 09/927,578

(22) Filed: Aug. 6, 2001

Related U.S. Application Data
(63) Continuation-in-part of application No. 09/669,069, filed on Dec. 20, 2000.
(60) Provisional application No. 60/289,936, filed on May 9, 2001.
(60) Provisional application No. 60/293,684, filed on May 25, 2001.

(51) Int. Cl. H04K 1/10; H04L 27/28; G10L 19/04

(52) U.S. Cl. 375/260; 704/220

(57) ABSTRACT

Methods and apparatus are described for effecting multi-band processing of an original sampled signal. The original sampled signal is separated into a plurality of signal components each corresponding to one of a plurality of frequency bands. A dynamic range associated with each one of the plurality of signal components is independently and dynamically controlled. At least one signal level associated with the plurality of signal components is modified. The signal components are combined into a processed sampled signal.

### RELATED APPLICATION DATA

The present application is a continuation-in-part application of U.S. patent application Ser. No. 09/669,069 for TECHNIQUES FOR IMPROVING AUDIO CLARITY AND INTELLIGIBILITY AT REDUCED BIT RATES OVER A DIGITAL NETWORK filed on Sep. 22, 2000, the entire disclosure of which is incorporated herein by reference for all purposes. The present application also claims priority from U.S. Provisional Applications No. 60/289,948 for DIGITAL SIGNAL PROCESSING TECHNIQUES FOR IMPROVING AUDIO CLARITY AND INTELLIGIBILITY filed on May 9, 2001, and No. 60/293,684 for DIGITAL SIGNAL PROCESSING TECHNIQUES FOR IMPROVING AUDIO CLARITY AND INTELLIGIBILITY filed on May 25,2001, the entire disclosures of both of which are incorporated herein by reference for all purposes.

### BACKGROUND OF THE INVENTION

The present invention relates generally to digital signal processing, and more specifically to the processing of digital audio signals in a variety of contexts.

At one point, the growth of the Internet was doubling every 18 months, with over 57 million Domain hosts as of July 1999. In the United States, over half of the population now has access to the Internet. This rapid development, in addition to the concurrent evolution of a variety of other content delivery mechanisms, e.g., digital broadcasting, cable and satellite system, etc., has fueled the explosive development of the digital audio industry. However, the quality of audio delivered by these various mechanisms is often limited by the low bit rate encoding schemes employed to deliver the audio, e.g., the MPEG layer 3 (MP3) encoding scheme.

Radio stations, concerts, speeches and lectures are all delivered over the web in streaming form. Encoders such as those offered by Microsoft and Real Audio reside on servers that deliver the audio stream at multiple bit rates over various types of connections (modem, T1, DSL, ISDN etc.) to a listener's computer. Upon receipt, the streamed data is decoded by a player, e.g., RealPlayer software, that understands the particular encoding format. Similarly, cable and satellite television systems deliver streaming video and audio to set top boxes in users' homes which decode and playback the encoded content.

Audio files (e.g., MP3 files) may also be downloaded over the Internet for storage and later playback using any of a variety of mechanisms including, for example, the listener's computer or any of a variety of available portable playback devices.

Regardless of the mechanism by which digital audio is delivered to the listener, there are a number of issues relating generally to the clarity and intelligibility of reproduced audio from the listener's perspective. These issues relate to any type of system which reproduces acoustic signals from digitally encoded information, e.g., portable music players, home entertainment systems, etc.

By way of example, in the encoding process of a typical low bit rate encoding scheme, e.g., the MP3 encoding scheme, undesirable artifacts are generated which interfere with the goal of faithfully reproducing a relatively high bandwidth signal (i.e., the original audio) using a low bandwidth technique (i.e., the low bit rate codec).

Such artifacts may be dealt with, at least in part, by appropriate processing of the analog or digital audio signals at their source (e.g., by the digital audio broadcaster). This is typically accomplished using a variety of techniques involving expensive hardware, software techniques with a high computational overhead, or both. Unfortunately, these costly techniques only deal with half of the equation.

That is, the ranges of listening environments, music types, and listener preferences make it virtually impossible to provide signal processing at the digital audio source which appropriately enhances the listening experience for each end user. This is exacerbated in systems in which the loudness level across the variety of available content is inconsistent. The processing capabilities which would enable customization according to each user's preferences may, of course, be included in the user's device. However, the cost of doing so in either hardware or processing resources has heretofore been prohibitive, not to mention technically challenging. This is particular true for the low cost, portable devices consumers demand.

It is therefore desirable to provide digital signal processing techniques which remove undesirable artifacts generated by digital encoding techniques (particularly low bit rate techniques), allow for customization of each listener's experience, and present a relatively small load on the processing resources of the audio delivery system.

### SUMMARY OF THE INVENTION

According to the present invention, a variety of digital signal processor configurations are enabled which may be flexibly configured to enhance the clarity and intelligibility of digital audio. Regardless of the encoding scheme employed, the delivery mechanism, the nature of the listening environment, or the preferences of the listener, the digital signal processors of the present invention may be configured to effect processing of the digital audio in a manner which enhances the listener's experience and imposes an acceptable level of computational overhead.

That is, the present invention provides methods and apparatus for effecting multi-band processing of an original sampled signal. The original sampled signal is separated into a plurality of signal components each corresponding to one of a plurality of frequency bands. The dynamic range associated with each one of the plurality of signal components is independently and dynamically controlled. At least one signal level associated with the plurality of signal components is modified. The signal components are combined into a processed sampled signal.

A further understanding of the nature and advantages of the present invention may be realized by reference to the remaining portions of the specification and the drawings.

### BRIEF DESCRIPTION OF THE DRAWINGS

FIGS. 1a and 1b show a simplified block diagram of a signal processor designed according to a specific embodiment of the present invention.

FIG. 2 is a simplified block diagram of various stages of a multi-band crossover for use with various specific embodiments of the present invention.

FIG. 3 is a flowchart illustrating operation of a crossover stage in the multi-band crossover of FIG. 2.

FIG. 4 is a flowchart illustrating operation of an automatic gain control processing block according to a specific embodiment of the invention.

FIG. 5 is a flowchart illustrating operation of a nonlinear automatic gain control processing block according to a specific embodiment of the invention.

FIG. 6 is a block diagram illustrating the playing of audio files over a network according to a specific embodiment of the present invention.

FIG. 7 is a block diagram illustrating the decoding of audio files according to a specific embodiment of the invention.

FIG. 8 is a block diagram illustrating the playing of audio files over a network according to another specific embodiment of the present invention.

FIGS. 9a and 9b show a simplified block diagram of a signal processor designed according to another specific embodiment of the present invention.

FIGS. 10a and 10b show a simplified block diagram of a signal processor designed according to yet another specific embodiment of the present invention.

FIG. 11 is a simplified block diagram of a signal processor designed according to a further specific embodiment of the present invention.

FIGS. 12a and 12b are block diagrams illustrating the transmission and receiving sides of a digital audio broadcasting system according to a specific embodiment of the invention.

FIG. 13 is a block diagram illustrating a satellite television system according to a specific embodiment of the present invention.

FIG. 14 is a block diagram of a home entertainment system designed according to a specific embodiment of the invention.

FIG. 15 shows a 3-band signal processor designed according to another specific embodiment which may be employed in voice or telephony applications.

### DETAILED DESCRIPTION OF SPECIFIC EMBODIMENTS

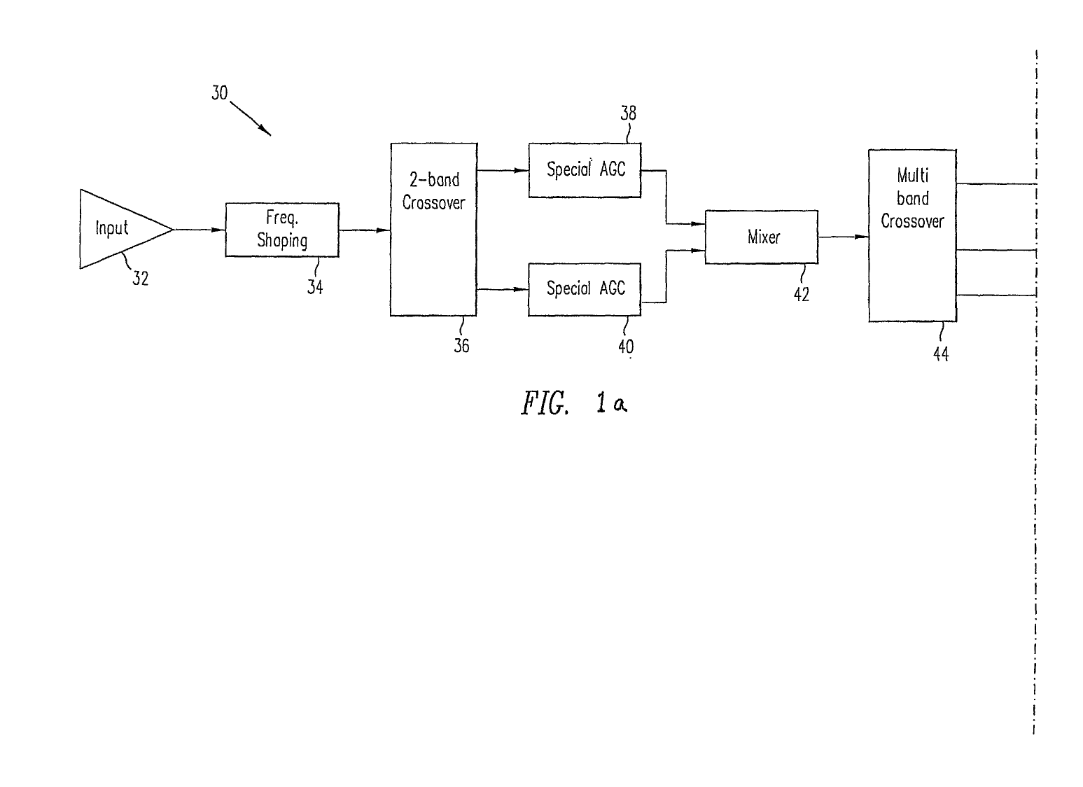

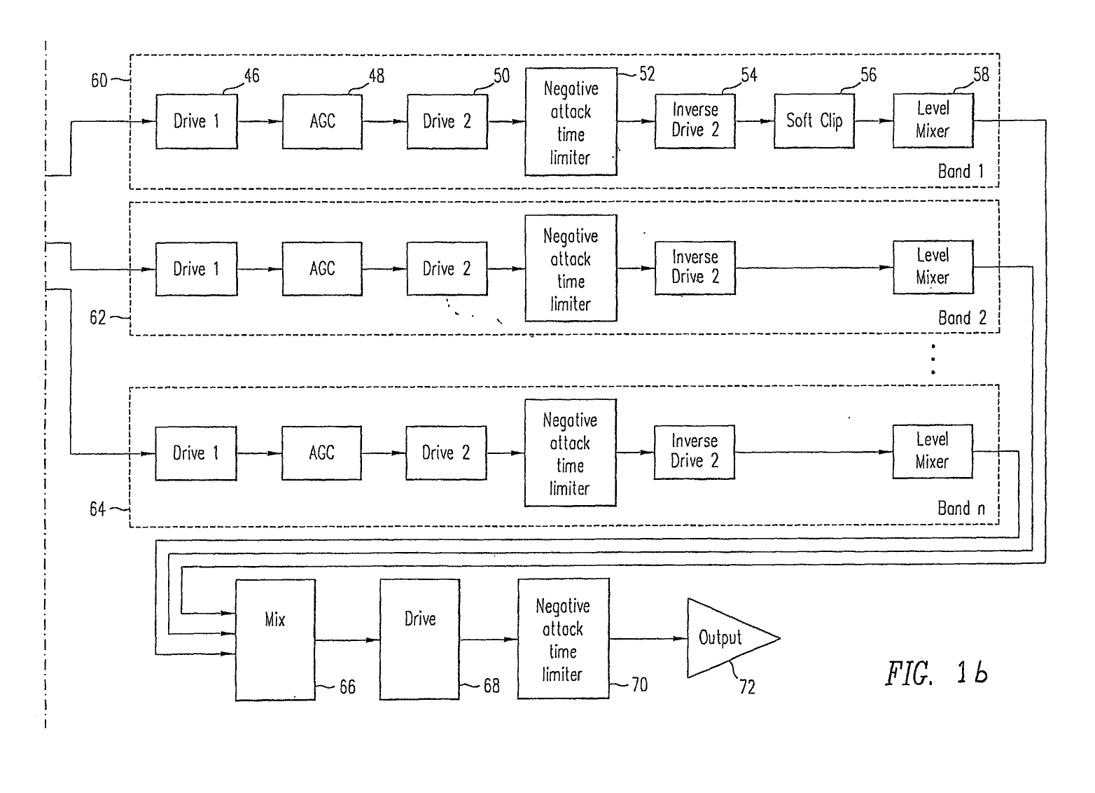

Referring now to FIGS. 1a and 1b, a block diagram of a signal processor 30 is shown for processing audio signals according to a specific embodiment of the present invention. In this embodiment, signal processor 30 is implemented entirely in software and may be incorporated, for example, within a server distributing digital audio files or streaming audio, or within any of a variety of other devices including, for example, digital radio transmitters and receivers, standard PCs, cell phones, personal digital assistants (PDAs), wireless application devices, portable playback devices, set top boxes, etc.

The input block 32 in FIG. 1a receives audio signals from an audio source (not shown). The input block 32 converts the audio signals into pulse code modulated (PCM) samples according to any of a wide variety of well known digital encoding schemes. Subsequently, at the frequency shaping block 34, the very low frequency components of the PCM samples are eliminated which may otherwise degrade the audio quality of the samples. According to a specific embodiment, block 34 is a high pass filter (e.g., 5 Hz) which removes the DC offset.

At the 2-band crossover block 36 the audio samples are separated into two partially overlapping frequency bands. According to a specific embodiment, all of the crossover blocks in processor 30 have a relatively shallow characteristic so that each band blends nicely with adjacent bands. Each frequency band is subsequently processed at non-linear automatic gain control (AGC) loop blocks 38 and 40 which, according to a specific embodiment, have less aggressive attack and release times than subsequent AGCs and are primarily for putting the signal level into the “sweet spot” of the subsequent multi-band crossover block 44.

In the non-linear AGC loops 38 and 40 each of the input samples is multiplied by a number known as the gain factor. Depending on whether the gain factor is greater or lower than 1.0, the volume of the input sample is either increased or decreased for the purpose of equalizing the amplitude of the input samples in each of the frequency bands. The gain factor is variable for different input samples as described in more detail below. The distinguishing factor between a non-linear AGC and an AGC is that the gain factor varies according to a nonlinear mathematical function in the non-linear AGC. Thus, the output of each of the non-linear AGCs 38 and 40 is the product of the input sample and the gain factor. According to a specific embodiment, AGCs 38 and 40 operate in a manner similar to that described below with reference to AGC 48 in processing block 60 of FIG. 1b. The outputs of the two non-linear AGCs are mixed at the mixer block 42 so that in the resulting output all the frequencies are represented.

At the next block, multi-band crossover 44, the audio samples are divided into n overlapping frequency bands, where n=3 or more. For a 5-band processor the bands may include, for example, sub-bass, mid-bass, mid-range, presence, and treble. Multi-band crossover 44 behaves very similar to 2-band crossover 36 except that the former has more frequency bands.

Because the samples are divided into multiple frequency bands, the volume in each frequency band may be equalized separately and independently from the other frequency bands. Independent processing of each frequency band is desirable where there is a combination of high-pitch, low-pitch and medium-pitch instruments playing simultaneously. In the presence of a high-pitch sound, such as crash of a symbol that is louder than any other instrument for a fraction of a second, a single band AGC would reduce the amplitude of the entire sample including the low and medium frequency components present in the sample that may have originated from a vocalist or a bass. The result is a degradation of audio quality and introduction of undesirable artifacts into the music. A one band AGC would allow the component of frequency with the highest volume to control the entire sample, a phenomenon referred to as spectral gain intermodulation.

Referring now to FIG. 1b, each frequency band is independently processed by processing blocks 60, 62, and 64. Processing block 60 is dedicated to processing band 1 with components possessing the lowest frequency. Drive block 46 is a user programmable gain adjustment which uniformly exaggerates the signal component as it goes into AGC 48 which works to reduce changes in the gain. For every Nth sample that doesn't overshoot its threshold, AGC 48 incrementally increases the gain. Likewise, for every Nth sample which does overshoot the threshold, AGC 48 incrementally decreases the gain.

Drive block 50 is another user programmable gain adjustment which precedes negative attack time limiter (NATL) 52. Drive block 50 works in concert with inverse drive block 54 to adjust the effective range of operation of NATL 52. For some signal transients which occur quickly, AGC 48 may not react quickly enough and some overshooting samples would go otherwise go untreated resulting in a sharp overshoot at the beginning of the transient. To deal with this, NATL 52 looks at future samples and limits the gain of the current sample to avoid the distortion associated with such sharp overshoots. In practical terms, the lower the threshold is set, the more “dense” the sound becomes.

According to a specific embodiment of NATL 52, samples are stored in a delay buffer so that the future samples may be used in equalizing the volume. When the buffer is full, a small block of earlier samples is extracted from the beginning of the buffer and the future block of samples is appended to the end of the buffer. The future sample is multiplied by the gain factor. If the resulting data has an amplitude greater than a threshold value (a user-fixed parameter) the gain factor is reduced to a value equal to the threshold value divided by the amplitude of the future sample. A counter referred to as the release counter is subsequently set equal to the length of the delay buffer. The resulting data are then passed through a low-pass filter so as to smooth out any abrupt changes in the gain that will have resulted from multiplication by the future sample.

Finally, the sample in the buffer which has been delayed is multiplied by the gain factor described above in order to produce the output. Subsequently, the release counter is decremented. If the release counter is less than zero, the gain factor is multiplied by a number slightly greater than 1.0. Finally, the next sample is read and the above process is repeated. NATL 52 ensures that the transition from the present sample to the future sample is achieved in a smooth and inaudible fashion, and removes peaks on the audio signal that waste bandwidth.

According to a specific 5-band audio implementation of processor 30, processing block 60 may include a soft clip block 56 which corresponds to a nonlinear function which essentially rounds off the waveform, creating harmonics which, in turn, create the effect that there is more bass than there is in the input signal. That is, within an output signal excursion which is less than the peak-to-peak excursion of the input signal from drive block 54 there is substantially more acoustic energy.

The level mixer block 58 is another gain control wherein the sample is multiplied by a constant gain factor that may be preset by the user. Remixing of the signal components in the different frequency bands is performed at the mixer block 66. Another user programmable gain control 68 for general loudness is followed by a final NATL 70 which limits the total peak of the combined bands in the same way as discussed above with reference to NATL 52. The limiting function performed by NATL 70 is desirable, for example, where constructive interference between peaks in different bands causes peaks which need to be dealt with. Finally, the output of signal processor 30 in the form processed audio samples is transmitted via output block 72.

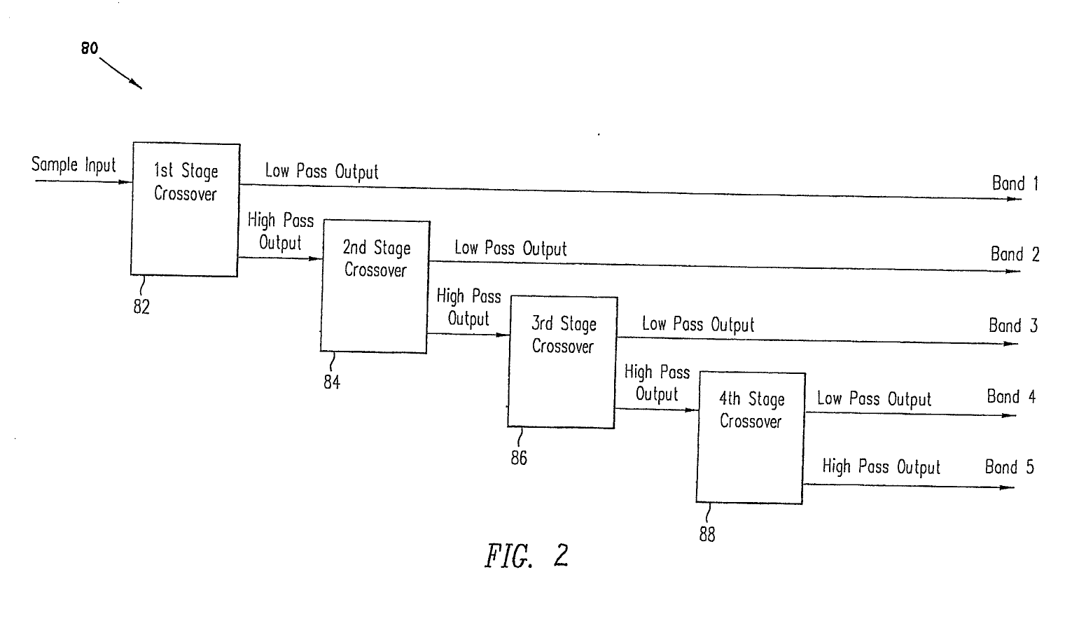

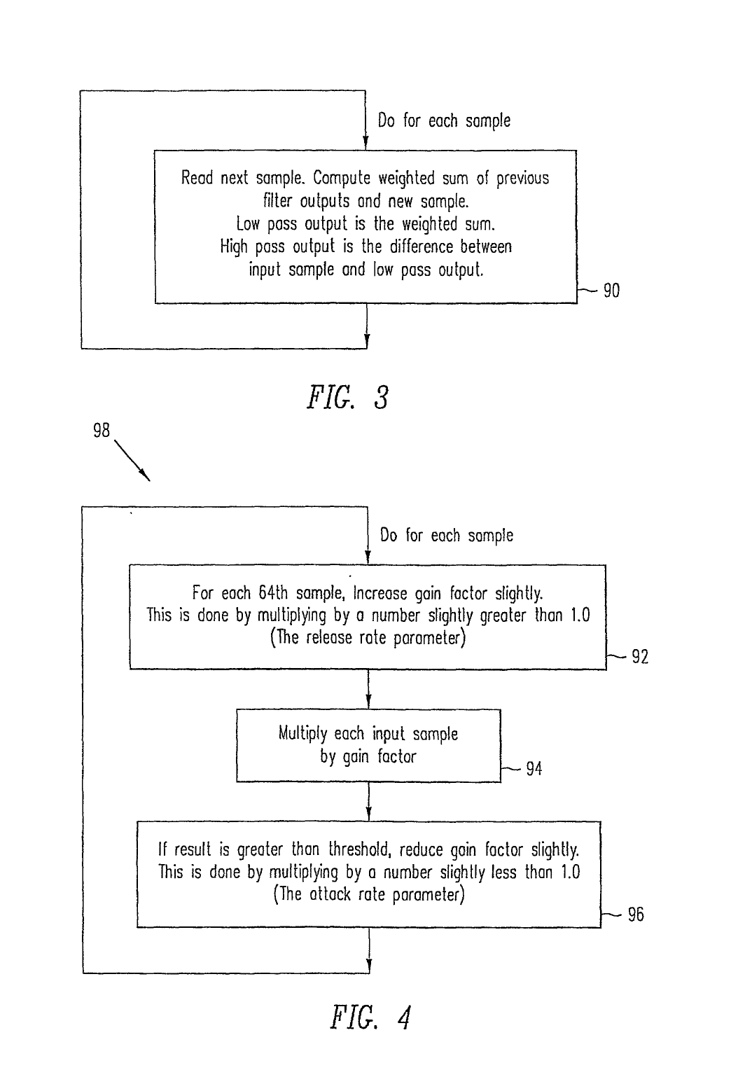

FIG. 2 shows the four stages of a 5-band crossover block 80 which may be employed as a specific embodiment of multi-band crossover 44 of FIG. 1a. Crossover block 80 represents a series of linear operations to separate signals into overlapping frequency bands. At each stage of the multi-band crossover 80 (as shown in FIG. 3) a computation is performed resulting in a high pass output as shown in the loop 90. More specifically, at each stage corresponding to a particular frequency band only the output from the previous stage, referred to as the high pass output, is read. An averaging process is then performed wherein the weighted sum of the previous stage's output and the new sample is computed.

The output of the averaging process is referred to as the low-pass output in FIGS. 2 and 3. Thus, there are n-1 low pass outputs corresponding to the n frequency bands. The difference between the input sample and the low pass output is denoted as the high pass output which forms the input to the next stage of the multi-band crossover. FIG. 2 shows four stages corresponding to the 1^{st}, 2^{nd}, 3^{rd}, and 4^{th} stages of the multi-band crossover labeled 82-88, respectively.

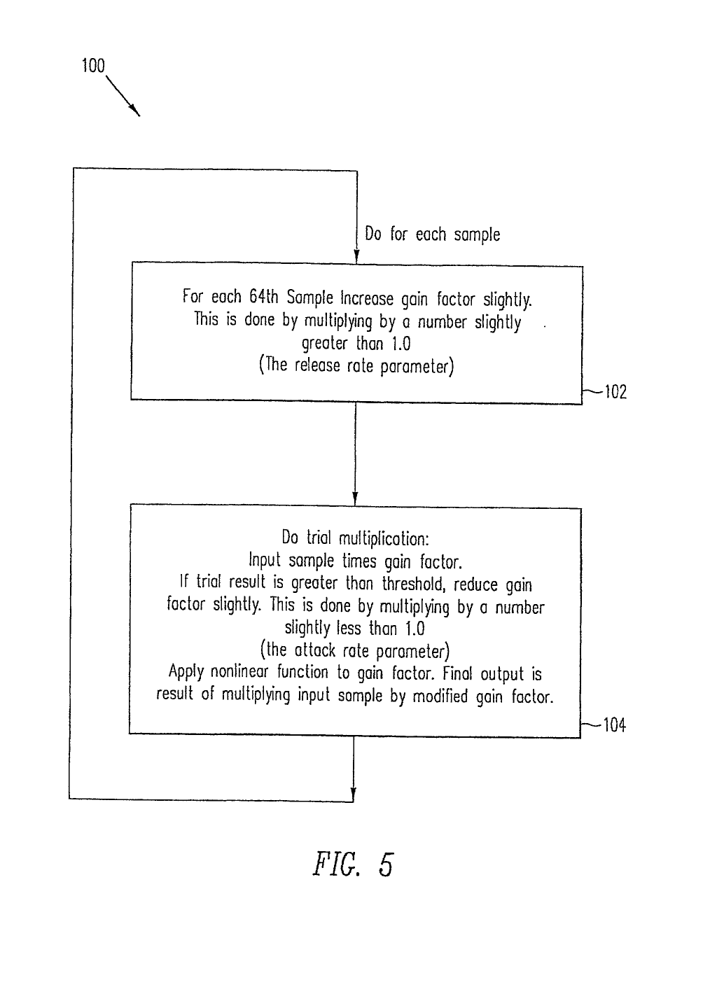

FIG. 4 shows a flowchart illustrating operation of a specific embodiment of an AGC loop 98 which may be employed, for example, to implement AGC 48 of FIG. 1b. AGC loop 98 applies a gain factor to each sample it receives. Initially the gain factor is assumed and thereafter for each sample, as indicated at 92, the gain factor is increased slightly through multiplication by a number greater than 0.0 referred to herein as the release rate parameter. In this way, the gain factor increases with every sample. Every input sample is multiplied by the gain factor thus obtained, as indicated at 94.

At 96 it is determined if the amplitude of the sample with the gain factor applied exceeds a preset threshold value. In the event the threshold value is exceeded, the gain factor is reduced slightly through multiplication by a number greater than 0.0 referred to herein as the attack rate parameter. Otherwise the gain factor remains unaltered and the process repeats by reading a new input sample.

FIG. 5 shows a flowchart illustrating operation of a specific embodiment of a special AGC loop 100 which may be employed, for example, to implement AGC 38 of FIG. 1b. The non-linear AGC loop 100 applies a gain factor to each sample it receives. At 102, the gain factor is increased for every sample by multiplying the gain factor with a number slightly greater 1.0, i.e., the release rate parameter. At 104, a trial multiplication is performed by multiplying each input sample with the gain factor. If the amplitude of the resulting signal is greater than a preset threshold value, the gain factor is reduced slightly by multiplication with a number slightly less than 1.0, i.e., the attack rate parameter. The gain factor is then modified according to a nonlinear function.

According to one embodiment of the present invention, the new gain factor is obtained by dividing the old gain factor by two and adding a fixed value to the outcome, thereby obtaining a nonlinear variation in the gain factor. The final output of the non-linear AGC loop 100 is obtained by multiplying each input sample by the modified gain factor. Thereafter, the process is repeated for the incoming new input samples.

Various embodiments of the present invention are implemented entirely in software. In one embodiment, a Pentium processor within a standard PC is programmed in assembly language to perform the generalized signal processing depicted in FIGS. 1a and 1b, resulting in considerable reduction in both expense and complexity. Furthermore, the present invention is implemented in real-time, making it particularly desirable for use in the transmission of audio signals over any digital network such as the Internet.

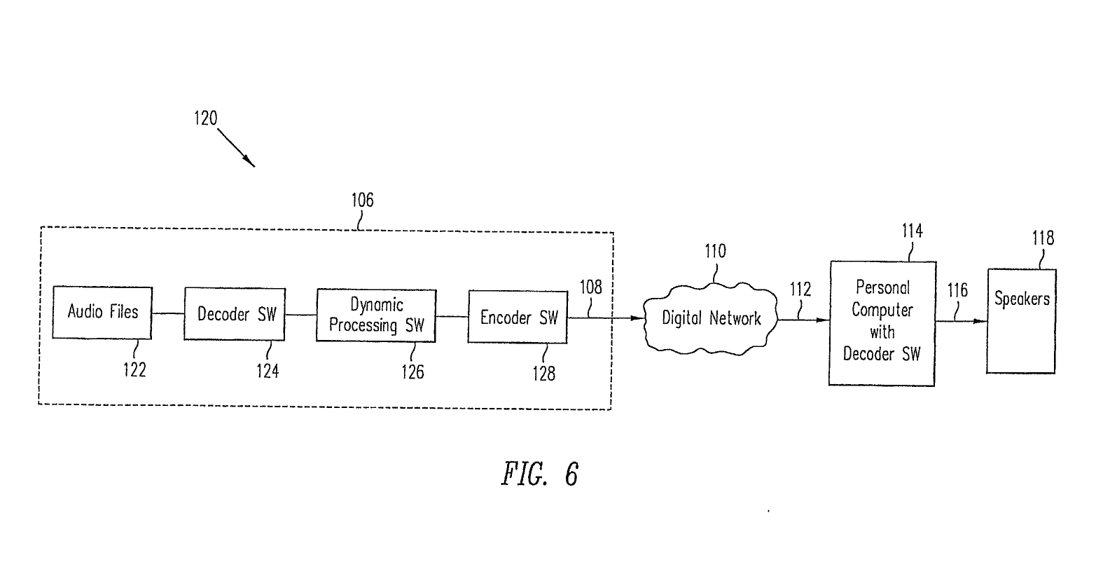

FIG. 6 depicts one application of the present invention wherein audio files are played over a digital network with dynamic processing optimization. FIG. 6 shows a communication system 120 comprising an audio server 106, a digital network 110, a PC 114 and speakers 118. Audio server 106 is coupled to the digital network 110 through transmission line 108, which may be a T1 line. Digital network 110 is coupled to the PC 114 through the transmission line 112 and the PC 114 is coupled to the speakers 118 through the line 116.

Within the audio server 106, which may be a PC or several connected PC's, are several blocks for the processing of audio signals. The audio files 122 stored on a disk may be encoded using any of a variety of encoding algorithms such as, for example, the MP3 encoding scheme. The audio files are played at 124 using a decoding software, e.g., Winamp, and are subsequently converted to PCM samples. The PCM samples are then processed by the signal processing software 126, embodiments of which are described herein, e.g., the processor of FIGS. 1a and 1b.

The output of the signal processing software 126 is encoded again using any desired encoding algorithm, e.g., MP3, and is transmitted through the line 108, across the digital network 110, and through the line 112 to the PC 114. Inside the PC 114, equipped with the appropriate decoding software such as Winamp, the samples are decoded and converted into audio signals which are then fed to the speakers 118 through the line 116.

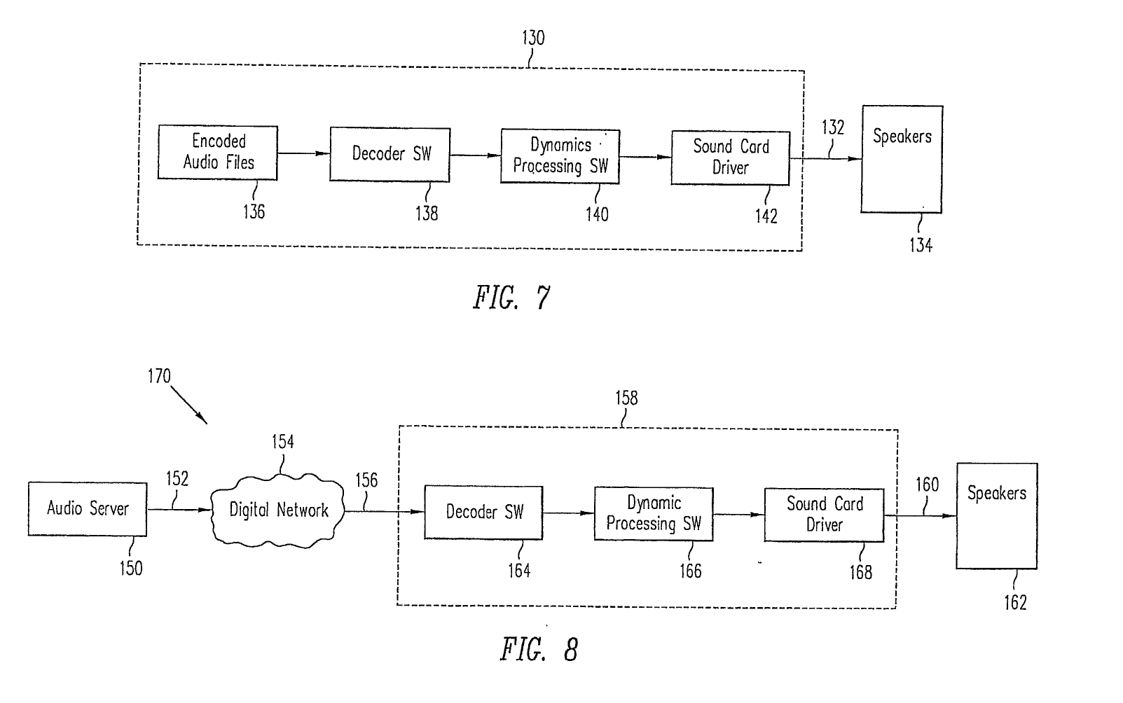

FIG. 7 shows another generalized application of the present invention wherein a user is playing audio files stored in a digital audio playback device 130. Speaker 134 is coupled to playback device 130 through the line 132. Playback device 130 may comprise, for example, any of a wide variety of consumer electronic devices which would benefit from the signal processing innovations of the present invention such as a personal computer, any component of a home entertainment system, a handheld communication device, a portable CD or MP3 player, etc. For example, playback device 130 might be part of an audio system located inside a user's car, the dynamic processing capabilities of the invention being employed to improve the quality of sound in the presence of the background noise typical in such an environment.

Audio files 136, encoded using any of a variety of encoding techniques, are decoded by decoding software 138 (e.g., Winamp) and are converted to PCM samples. The PCM samples are processed by signal processing software 140 designed according to any of the various embodiments of the present invention.

It should be noted that signal processing software 140 may employ a greater or fewer number of frequency bands and processing blocks than various ones of the embodiments described herein. That is, for different applications, a greater or lesser amount of processing resources are available to effect the signal processing techniques of the present invention. For example, the available number of processing cycles in a small portable playback device such as an MP3 player may be limited. By contrast, such limitations may not exist for an audio server such as server 106 of FIG. 6.

The output of signal processing software 140 is finally converted to audio signals at conversion block 142 (which, in a PC, may be a sound card) which drives speakers 134 via line 132.

FIG. 8 shows yet another application of the present invention wherein the signal processing techniques described herein are employed at the receiving end of a network communication system. Shown in FIG. 8 is a communication system 170 including an audio server 150, a digital network 154, a PC 158, and speakers 162. The audio server 150 is coupled to the digital network 154 through the transmission line 152, the digital network 154 is coupled to the PC 158 through the transmission line 156, and the PC 158 is linked to the speakers 162 through the line 160.

The audio server 150 in this case may or may not include signal processing software designed according to any of the embodiments of the present invention. Encoded PCM samples are transmitted from the audio server 150 through the transmission line 152, across the digital network 154 and through the transmission line 156 to the PC 158. Inside the PC 158, the PCM samples are decoded at 164 using the appropriate decoding software. The decoded PCM samples are processed by signal processing software 166. The output of the signal processing software 166 is converted into audio signals by the sound card driver 168 which drives speakers 162 via line 160.

The AGC and NATL blocks used in the various embodiments of the present invention are quite similar with the differences being largely due to the adjustment of time constants, i.e., the attack and release times, for different implementations and for different effects within the same implementation. That is, a particular desired sound might affect the attack and release times specified for specific blocks. In addition, available processing resources might affect the number of bands and/or blocks per band in a particular implementation, e.g., a small cycle budget in an MP3 player vs. a large cycle budget in a music file server.

As the bandwidth of encoders are reduced relative to the bandwidth of the original audio, undesirable audible artifacts are generated. The present invention processes the audio samples such that these anticipated artifacts become less noticeable to the human ear. That is, the signal processing of the present invention allows a low bit rate encoder to be used to encode an audio stream without suffering overly much from the undesirable artifacts created by trying to faithfully reproduce a high bandwidth signal (the original audio) with a low bandwidth system (the low bit rate codec).

In addition to facilitating the bandwidth savings represented by low bit rate encoders, the signal processing of the present invention may have other desirable effects such as, for example, the improvement of clarity in the presence of background noise and cut-to-cut evenness.

A generalized topology of the present invention includes three different kinds of blocks, AGCs (including NATLs), drive blocks (e.g., drive blocks 46, 50 and 54 of FIG. 1b), and filter blocks (e.g., crossovers 36 and 44 of FIG. 1a). Signal processing networks combining these three elements in any of a wide variety of ways are considered within the scope of the invention. As described above, filter or crossover blocks typically are employed to perform a series of linear operations to separate signals into overlapping frequency bands.

In general, the AGC blocks of the present invention examine the recent history and/or immediate future of the signal and use this information to adjust a gain factor such that the signal is kept within a range of peak excursion. Different implementations of such blocks in various embodiments differ as to how much of the signal is used to make these adjustments, and how fast or how often the adjustments are made. Also specified is the range of signals desired to be maintained at the output e.g., use of a threshold to act or not act in, for example, a NATL. In addition, once the gain value to be applied is determined, a further nonlinear function may be applied to the gain value before applying it to the current sample. Finally, the gain value may also be calculated with reference to the input signal level. Both feed forward and feed back AGC topologies may be employed according to various embodiments of the invention. There are two fundamental types of AGCs employed by the various embodiments of the invention, 1) the limiter type (e.g., NATL 52 of FIG. 1b), and 2) the dynamic range control type (e.g., AGC 48 of FIG. 1b).

Drive blocks are simply preset level controls for putting samples in the sweet spot for subsequent processing block(s). Putting the processing block(s) between a drive block and an inverse drive block allows the processing block(s) to operate within its normal range while moving the effective range relative to the audio signal.

According to a specific embodiment, the efficiency with which the fundamental blocks of the signal processors of the present invention operate relates in part to the use of low-precision integer arithmetic to implement the blocks' functions. According to a more specific embodiment, separation of the work of the AGC and the NATL into two independent stages also contributes to efficiency and sound quality.

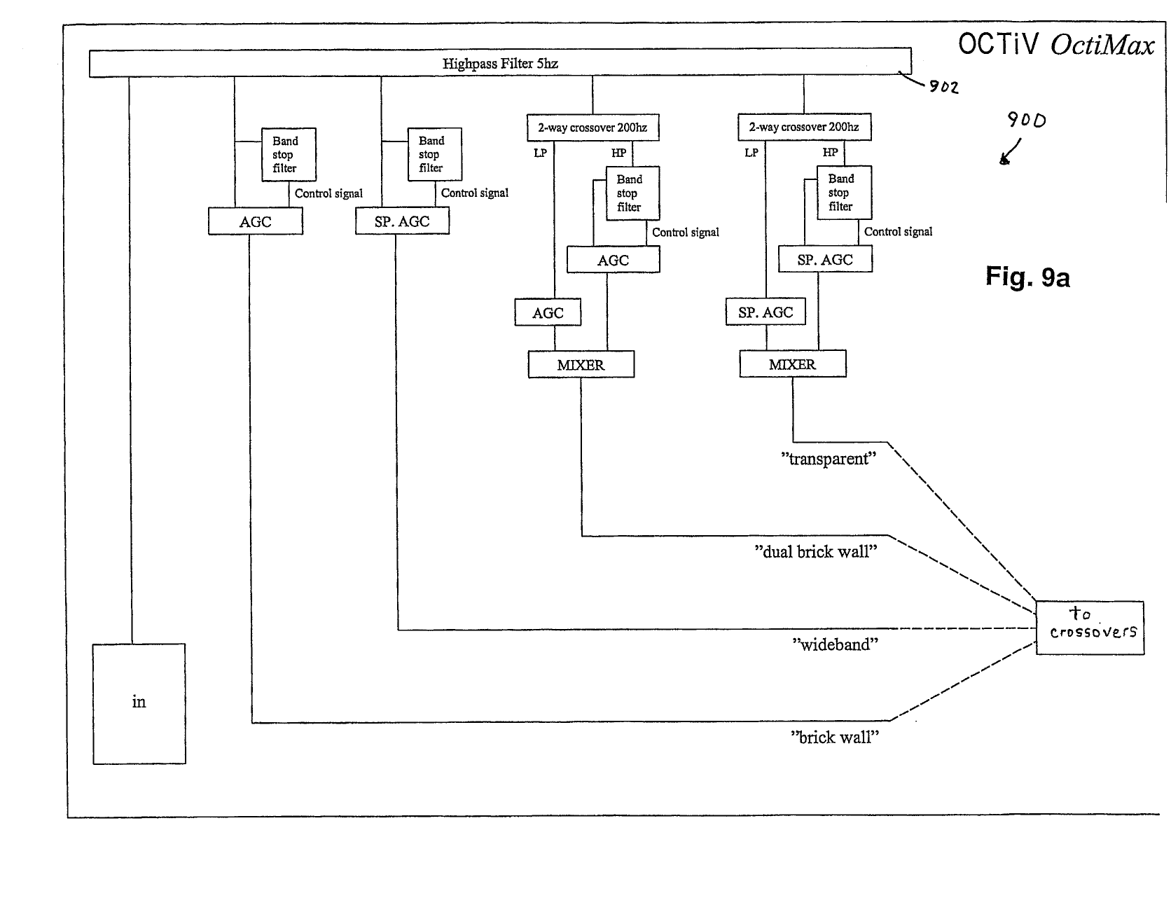

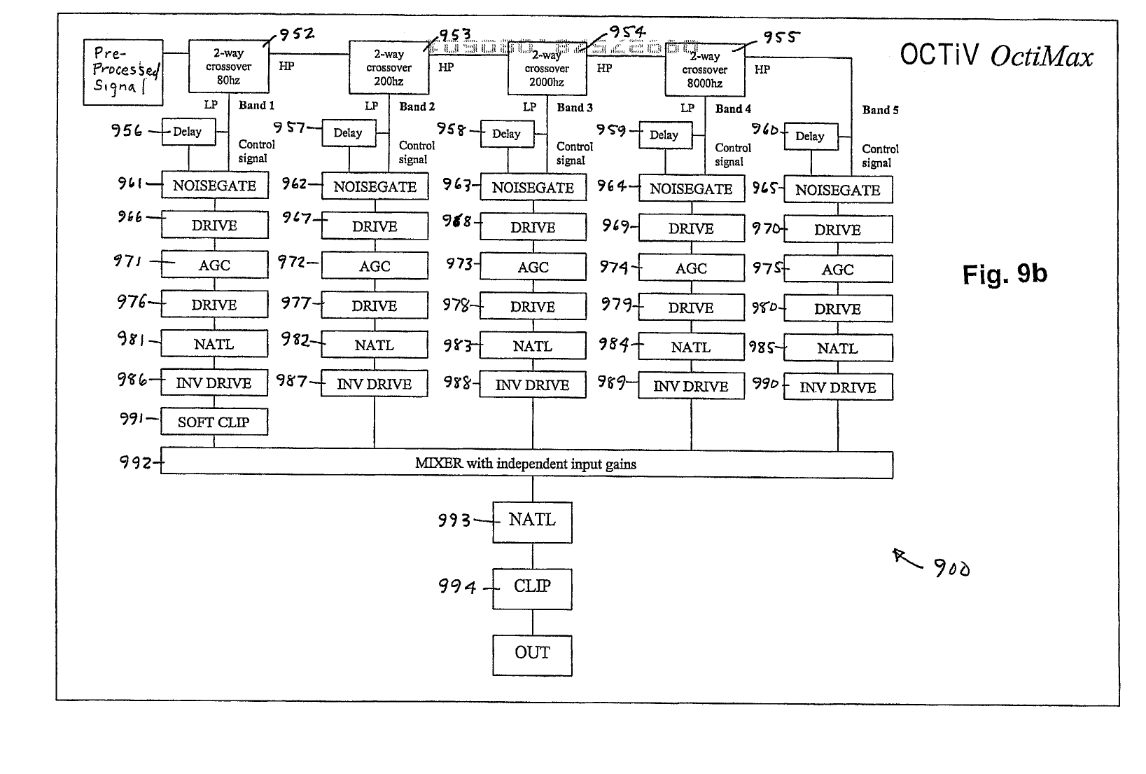

Additional embodiments of the present invention will now be described with reference to FIGS. 9a and 9b and subsequent figures. FIGS. 9a and 9b show a 5-band signal processor 900 designed according to a specific embodiment of the present invention. It should be noted that the processing blocks of processor 900 operate in a similar manner to the corresponding blocks of processor 30 described above with reference to FIGS. 1a and 1b. It should also be understood that processor 900 may be employed for a wide variety of applications, particularly those application which have sufficient processing overhead to accommodate the associated computational load presented by this configuration.

Referring now to FIG. 9a, the received digital audio samples are high pass filtered in filter block 902 to suppress the DC component and other unnecessary signal components below 5 Hz. The filtered samples are then pre-processed in one of four parallel paths referred to herein as the “transparent,” “dual brick wall,” “wideband,” and “brick wall” paths, respectively.

According to a specific embodiment of the invention, the “transparent” path divides the audio into two bands (bass and master) and processes them individually (with the bass band coupled to the master band). This can be thought of as a standard mode having negligible effect. The “dual brick wall” path is the same as the “transparent” path except that it is more audible in its gain changes. The “wideband” path processes the full-range audio with only one AGC. This provides slight spectral gain intermodulation which, in some embodiments, is exploited by the certain presets (e.g., rock presets). The “brick wall” path is like the “wideband” path but provides considerable spectral gain intermodulation which, according to various embodiments, may be exploited by certain presets (e.g., so called club or house presets).

The pre-processed audio is then divided into five frequency bands using 2-way crossover blocks 952-955 having cutoff frequencies of 80 Hz, 200 Hz, 2 kHz, and 8 kHz, respectively. This may be accomplished, for example, as described above with reference to the multi-band crossover of FIG. 3. The samples in each of Bands 1-5 are then subjected to further processing as follows.

Noisegate blocks 961-965 remove components of the audio signal that are below a certain level of amplitude. Delay blocks 956-960 are used by noisegate blocks 961-965 for look-ahead/negative attack time.

Drive blocks 966-970 represent user programmable gain adjustments which uniformly exaggerate the received signal component as it goes into the following AGC block (i.e., 971-975) which works to reduce changes in the gain. According to a specific embodiment, for every nth sample that doesn't overshoot its threshold, each of AGC blocks 971-975 incrementally increases its gain. Likewise, for every mth sample which does overshoot the threshold, each of AGC blocks 971-975 incrementally decreases the gain. According to a more specific embodiment, the release function of AGC blocks 971-975 is given by:

gain=gain+(gain*release)

and the attack function of AGC blocks 971-975 is given by:

gain=gain−(gain*attack)

where “release” and “attack” represent the release and attack time constants, respectively.

Drive blocks 976-980 are another set of user programmable gain adjustments which precede negative attack time limiters (NATLs) 981-985. For some signal transients which occur quickly, AGCs 971-975 may not react quickly enough and some overshooting samples would go otherwise go untreated resulting in a sharp overshoot at the beginning of the transient. To deal with this, NATLs 981-985 look at future samples and limit the gain of the current sample to avoid the distortion associated with such sharp overshoots. The lower the threshold is set, the more “dense” the sound becomes.

Each of drive blocks 986-990 is the inverse of the corresponding one of drive blocks 976-980. Each of drive blocks 976-980 works in concert with the corresponding one of inverse drive blocks 986-990 to adjust the effective range of operation of the corresponding one of NATLs 981-985. In addition, in band 1, e.g., sub-bass, drive block 986 feeds soft clip block 991 which corresponds to a nonlinear function which essentially rounds off the waveform, creating harmonics which create the perception that there is more bass than there is, i.e., within the same peak-to-peak excursion of the input signal there is a lot more acoustic energy in the output because of the harmonics.

Mixer block 992 which has independently controllable gain for each band is followed by a final NATL 993 which limits the total peak of the combined bands, e.g., constructive interference between peaks in different bands may cause peaks which need to be dealt with. NATL 993 is followed by Clip block 994 which removes any remaining overshoots from the signal.

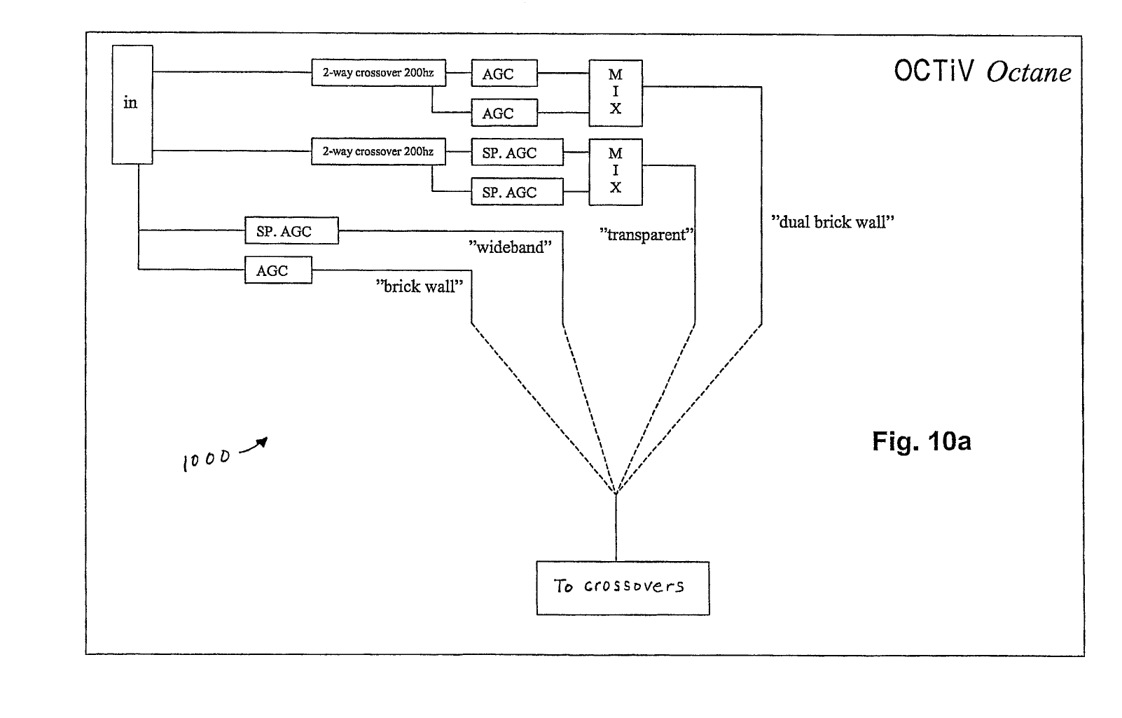

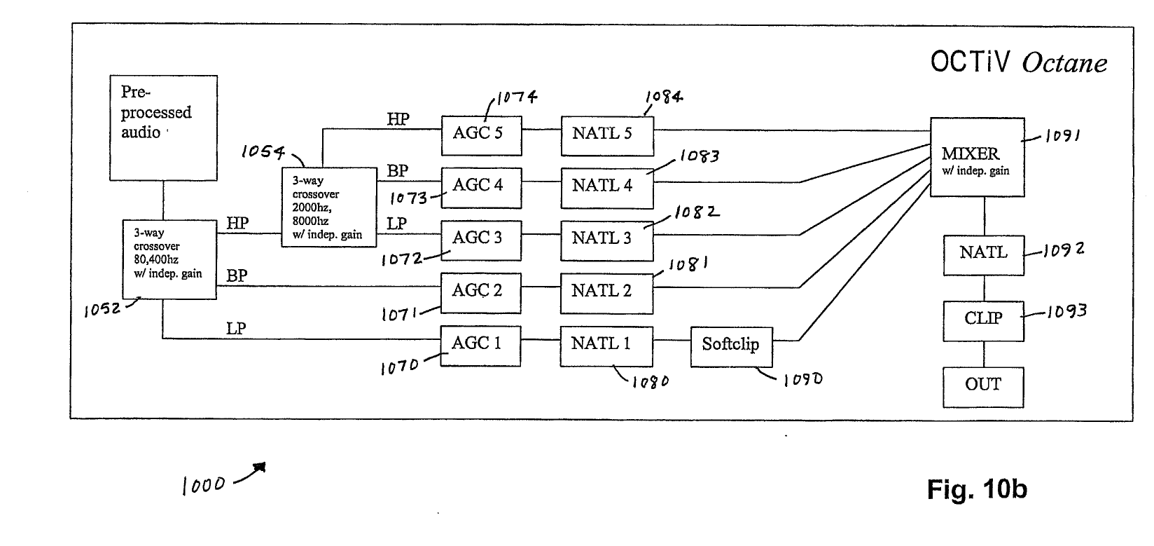

FIGS. 10a and 10b show another 5-band signal processor 1000 designed according to yet another embodiment of the invention. This embodiment of the invention has an advantage with respect to processor 900 of FIGS. 9a and 9b in that it represents a lower load on the system's overall processing resources, i.e., it has a lower cycle budget, due to a few simplifications. It should also be noted that, with some exceptions noted below, the processing blocks of processor 1000 operate in a similar manner to the corresponding blocks of processors 30 and 900 described above. Indeed, as can be seen in FIG. 10a, the input samples are pre-processed in one of four parallel paths in much the same way (with the exception of the band-pass filters) as described above with reference to FIG. 9a.

The preprocessed audio is then divided into five frequency bands using two three-way crossover blocks 1052 and 1054, each having cutoff frequency pairs of 80 and 400 Hz, and 2 and 8 kHz, respectively (instead of the four crossovers 952-955 in FIG. 9b). In addition, crossover blocks 1052 and 1054 include independent user programmable gain controls which eliminate the need for the subsequent drive blocks in other embodiments. The samples in each of Bands 1-5 are then subjected to further processing as follows.

According to a specific embodiment, for every sample received that doesn't overshoot its threshold, each of AGC blocks 1070-1074 incrementally increases its gain. Likewise, for every sample which does overshoot the threshold, each of AGC blocks 1070-1074 incrementally decreases the gain. According to a more specific embodiment, the release function of AGC blocks 1070-1074 is given by:

gain=gain+(gain/(2ˆ release))

and the attack function of AGC blocks 1070-1074 is given by:

gain=gain−(gain/(2ˆ attack))

where “release” and “attack” represent the release and attack time constants, respectively.

For some signal transients which occur quickly, AGCs 1070-1074 may not react quickly enough and some overshooting samples would go otherwise go untreated resulting in a sharp overshoot at the beginning of the transient. To deal with this, NATLs 1080-1084 look at future samples and limit the gain of the current sample to avoid the distortion associated with such sharp overshoots.

In addition, in the lowest frequency band, e.g., sub-bass, soft clip block 1090 corresponds to a nonlinear function which essentially rounds off the waveform, creating harmonics which create the perception that there is more bass than there is, i.e., within the same peak-to-peak excursion of the input signal there is a lot more acoustic energy in the output because of the harmonics.

Mixer block 1091 which has independently controllable gain for each band is followed by a final NATL 1092 which limits the total peak of the combined bands, e.g., constructive interference between peaks in different bands may cause peaks which need to be dealt with. NATL 1092 is followed by Clip block 1093 which removes any remaining overshoots from the signal.

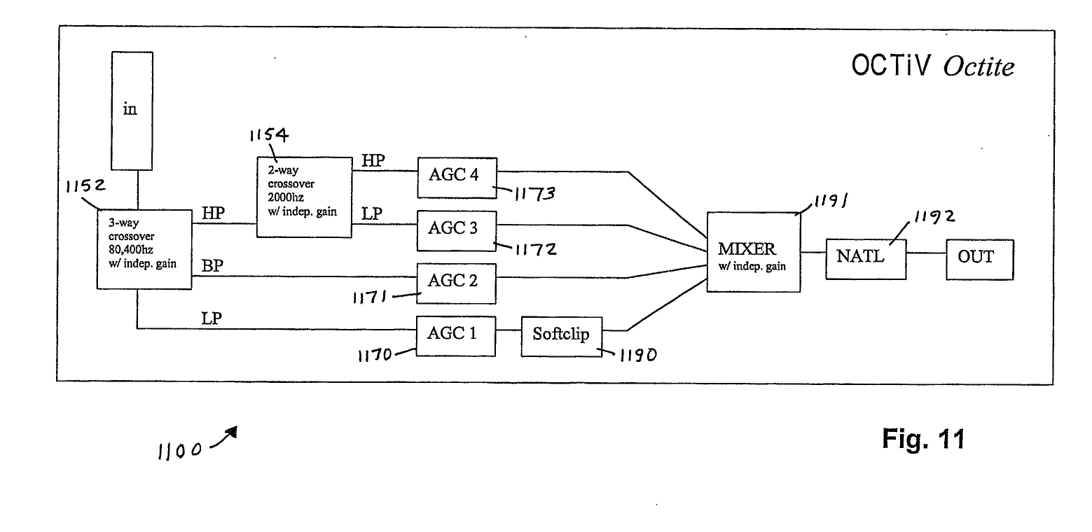

FIG. 11 shows a 4-band signal processor 1100 designed according to still another embodiment of the invention. This embodiment of the invention presents an even lower load on processing resources than the previously described embodiments due to additional simplification. As such, this embodiment is particularly amenable to applications in which a fairly sophisticated level of signal processing is desired, but which have a paucity of processing resources, e.g., portable digital audio players such as MP3 and CD players. It should also be noted that, with some exceptions noted below, the processing blocks of processor 1100 operate in a similar manner to the corresponding blocks of processors 30, 900, and 1000 described above.

The received audio samples are divided into four frequency bands using one three-way crossover block 1152 and one two-way crossover block 1154, having cutoff frequencies of 80 and 400 Hz, and 2 kHz, respectively. In addition, crossover blocks 1152 and 1154 include independent user programmable gain controls which eliminate the need for the subsequent drive blocks in other embodiments.

According to a specific embodiment, for every sample received that doesn't overshoot its threshold, each of AGC blocks 1170-1173 incrementally increases its gain. Likewise, for every sample which does overshoot the threshold, each of AGC blocks 1170-1173 incrementally decreases the gain. According to a more specific embodiment, the release function of AGC blocks 1170-1173 is given by:

gain=gain+(gain/(2ˆ release))

and the attack function of AGC blocks 1170-1173 is given by:

gain=gain−(gain/(2ˆ attack))

where “release” and “attack” represent the release and attack time constants, respectively.

Mixer block 1191 which has independently controllable gain for each band is followed by a final NATL 1192 which limits the total peak of the combined bands, e.g., constructive interference between peaks in different bands may cause undesirable peaks in the output signal.

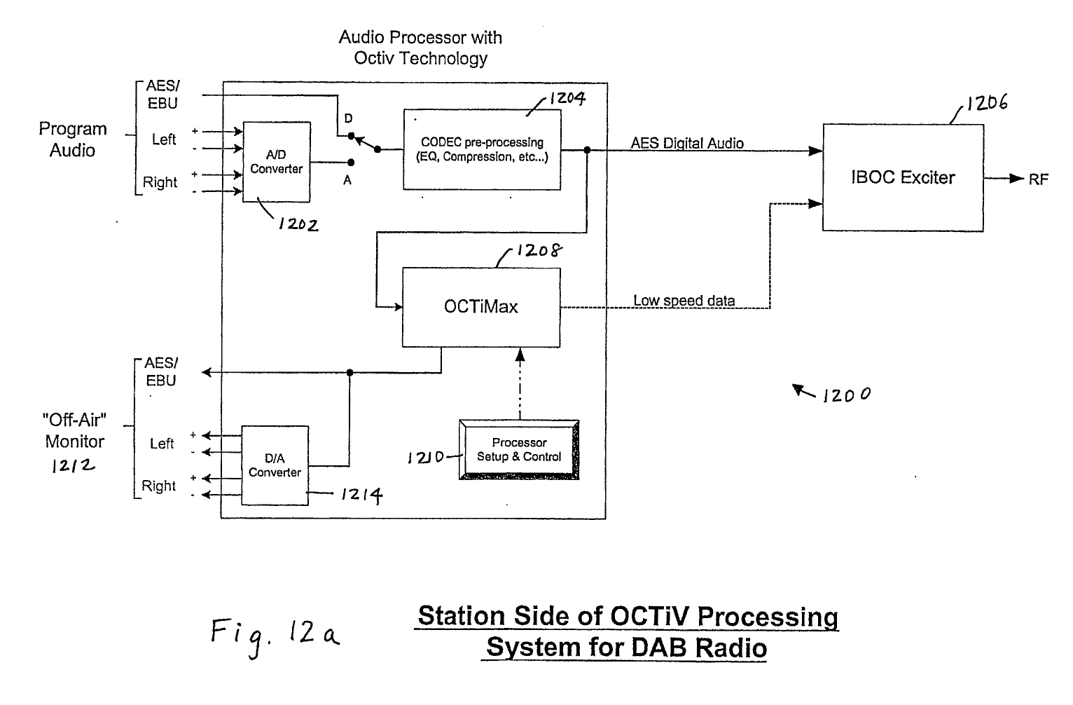

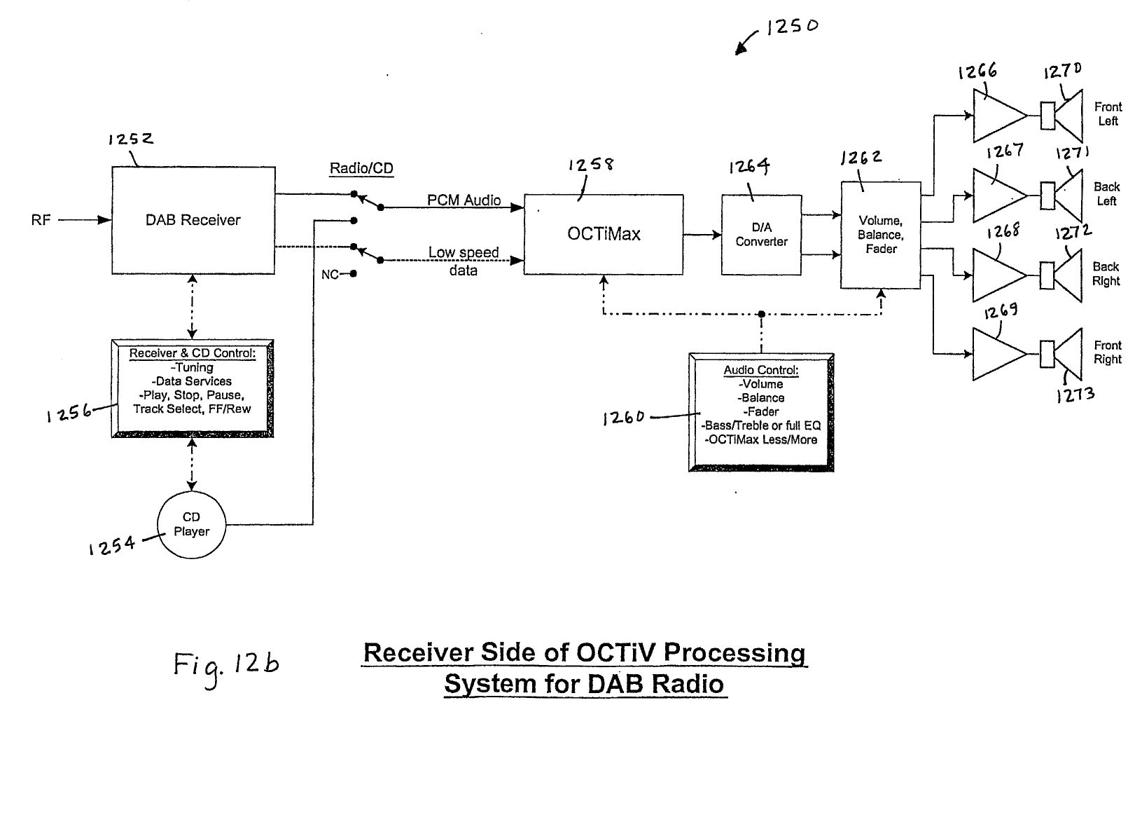

Specific applications will now be described with reference to FIGS. 12a through 14. It will be understood that the systems depicted are merely examples of systems which would benefit from utilization of various ones of the signal processing techniques of the present invention. As described above, there are a great many more applications for these techniques contemplated which are within the scope of the present invention.

Recent and ongoing developments in the digital radio industry will eventually result in a high-quality digital path from the broadcaster to the consumer which is largely devoid of dynamic range limitations and the problematic requirement of pre-emphasis. The complete digitization of the audio delivery chain will mean that audio will remain in the digital domain for the entire path from the original recording to the consumer while maintaining its original quality and dynamic range, a feat only previously possible, for example, when listening directly to a compact disc player.

The preservation of virtually all of the audio signal's dynamic range by such systems will allow a much wider dynamic range control than previously possible, enabling ever more sophisticated processing of the audio signal for artistic and other purposes. Unfortunately, regardless of the level of processing sophistication, the digital broadcaster cannot currently provide a digital audio signal which is appropriate for every listening environment, not to mention for every listener's preference. The best the broadcaster can hope to do is to process the audio signal for a particular “signature” sound with reference to some normalized “lowest common denominator” listening experience. Such an approach severely limits the dynamic range of the delivered signal, often making the listening experience unsatisfactory for a substantial number of listeners.

Many of the drawbacks of current digital broadcasting schemes relate to the fact that the audio processing occurs at the source of the audio signal, i.e., the digital broadcaster's radio transmitter, and as a result cannot meet the specific needs of each individual listener. Therefore, according to a specific embodiment of the present invention, a digital broadcasting system is proposed in which the digital signal processing techniques of the present invention are employed to overcome this problem. That is, processing capabilities are provided in the radio receiver which will allow customization of the listening experience according to each listener's preferences.

FIGS. 12a and 12b are simplified block diagrams of a digital audio broadcasting (DAB) station 1200 and a DAB receiver-side system 1250, respectively. Radio station 1200 receives the program audio signal which may be an analog signal which is subsequently converted to a digital signal by A/D converter 1202 or an AES/EBU digital signal, one of which is then encoded using the station's codec 1204. The resulting AES digital audio signal is then provided to IBOC exciter 1206 which uses it to modulate a broadcast RF signal.

The output AES digital signal is also provided to a signal processor 1208 designed according to the present invention. According to a more specific embodiment, processor 1208 comprises processor 900 of FIGS. 9a and 9b. However, it will be understood that any of a variety of embodiments of the invention may be used.

Processor 1208 is configured by the digital broadcaster via control interface 1210 to effect a variety of goals including, for example, providing the station's “signature” sound. The resulting audio signal may be monitored by the broadcaster's personnel via an off air monitor 1212 which receives both a processed AES/EBU digital signal and a two-channel processed audio signal provided by D/A converter 1214. In this way, the broadcaster's desired sound can be achieved.

Unlike previously described embodiments, processor 1208 does not process the digital audio prior to transmission. Instead, low speed digital data representing the desired processor configuration are provided to exciter 1206 for transmission on the RF signal along with the digital audio. These data may then be employed by the listener's system to configure a corresponding signal processor on the receiver side to process the digital audio signal in accordance with the broadcaster's programmed scheme. The configuration data set may include any of the parameters for any of the processor blocks, and may be less or more inclusive according to the broadcaster's design.

Referring now to FIG. 12b, DAB receiver-side system 1250 includes a DAB receiver 1252 and a compact disc (CD) player 1254 each of which may be controlled by the user via control circuitry 1256 which may include, for example, a remote control (not shown). As shown in the figure, the user may select between receiver 1252 and CD player 1254 as the audio source.

If the user selects DAB receiver 1252, both the PCM audio data and the low speed processor configuration data sent by station 1200 are provided to signal processor 1258 which, according to a specific embodiment comprises processor 900 of FIGS. 9a and 9b. It will, however, be understood that any of a wide variety of implementations may be used. Processor 1258 is configured according to the received low speed data and processes the digital audio data accordingly. The listener may customize the configuration of processor 1258, augmenting or completely overriding the broadcaster's default configuration using control interface 1260 which, according to the embodiment shown, is also operable to control the system's volume, balance, and fader functions represented by block 1262.

Processor 1258 provides the processed digital audio samples to D/A converter 1264 which, in turn, provides the converted analog signal to volume/balance/fader block 1262, the output of which is provided to amplifiers 1266-1269 which drive speakers 1270-1273, respectively.

In this way, the listening experience provided by the digital broadcasting system can be customized to conform to each listening environment and according to each listener's preference, while retaining some level of control for the baseline experience in the hands of the broadcaster. That is, according to various embodiments, the user is given the option of selecting the predefined default processing configuration provided by the digital broadcaster, altering that configuration in some way, or completely overriding. The integration of these capabilities into the listener's system is made possible, at least in part, by the fact that the processing techniques of the present invention may be implemented with a very small impact on the processing resources already available in most such systems.

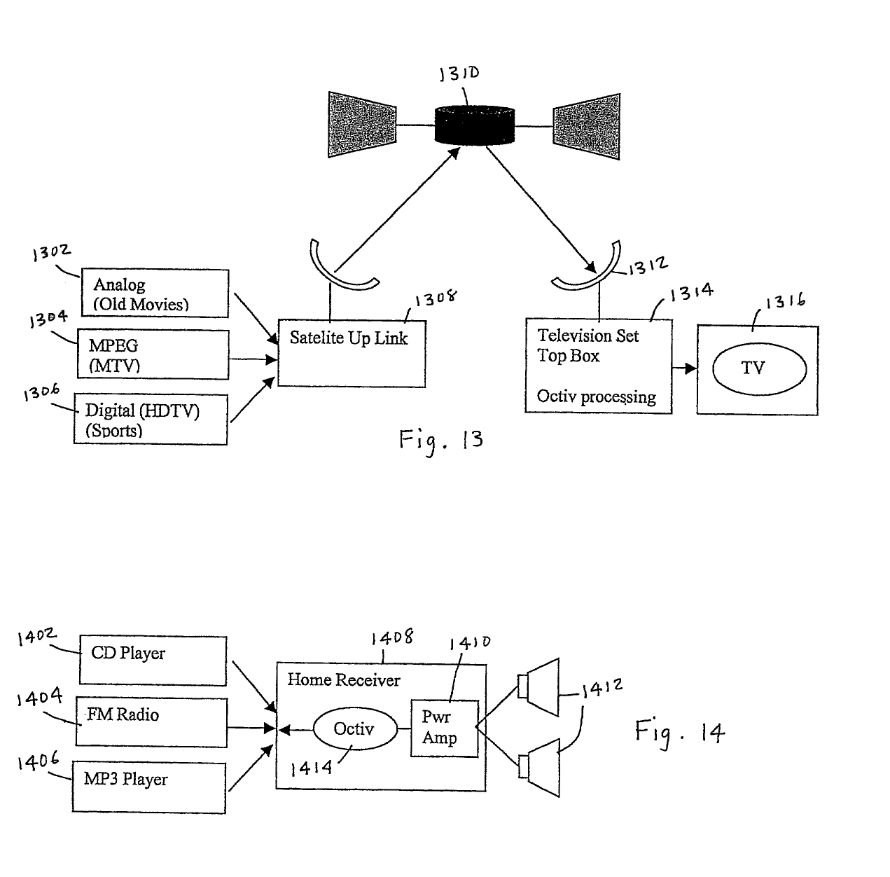

In fact, the low impact of the signal processors of the present invention makes these processor ideal for integration into a wide variety of applications. One such application is in a satellite television system such as the one shown in FIG. 13. As represented by boxes 1302, 1304, and 1306, satellite system 1300 employs a variety of disparate sources for the content it transmits to customers. This typically results in an uneven loudness across different channels and even for different content on a single channel which is undesirable from the end user's perspective.

This may of course be dealt with by integrating the processing techniques of the present invention into the satellite system's headend equipment. However, as discussed above with reference to the digital broadcasting context, this only addresses part of the problem. It still does not allow for customization of the individual user's listening experience. Therefore, according to the embodiment of the present invention, the processing techniques of the present invention are integrated into the user's equipment in much the same way as in the digital broadcasting system to provide the desired signal processing capabilities.

Referring again to FIG. 13, different types of content (1302, 1304, and 1306) are provided to the headend's satellite uplink 1308 which may or may not include some level of signal processing capability either according to the present invention or some other technique. The content is transmitted to satellite 1310 which then transmits the content to a user's antenna 1312 for decoding by a set top box 1314 and presentation on television 1316. According to one embodiment, a signal processor designed according to the present invention (e.g., processor 1100 of FIG. 11) is included in set top box 1314 and may be configured according to configuration data transmitted along with the content by the satellite provider in a manner similar to that described above with reference to FIGS. 12a and 12b. Alternatively, a default configuration may be provided in the set top box itself. In either case, the user can either alter or override the default processor configuration using, for example, a menu driven interface which is accessed via television 1316 and an associated remote control (not shown). It will be understood, of course, that the preceding discussion applies equally well to a cable television system.

According to an alternate embodiment, a signal processor designed according to the invention is provided in the television set itself. In fact, any system which includes audio derived from disparate sources may benefit from the signal processing and normalization capabilities of the present invention. For example, referring now to FIG. 14, a home entertainment system 1400 may include multiple sources of audio signals such as a CD player 1402, an FM radio receiver 1404, and an MP3 player 1406. These audio signals may be received by a receiver 1408 which amplifies them using power amp 1410 which drives speakers 1412. As shown, receiver 1408 includes a signal processor 1414 designed according to the present invention which may be configured to eliminate the unevenness resulting from the differences between the audio sources, and which allows the user to customize the listening experience according to his preferences.

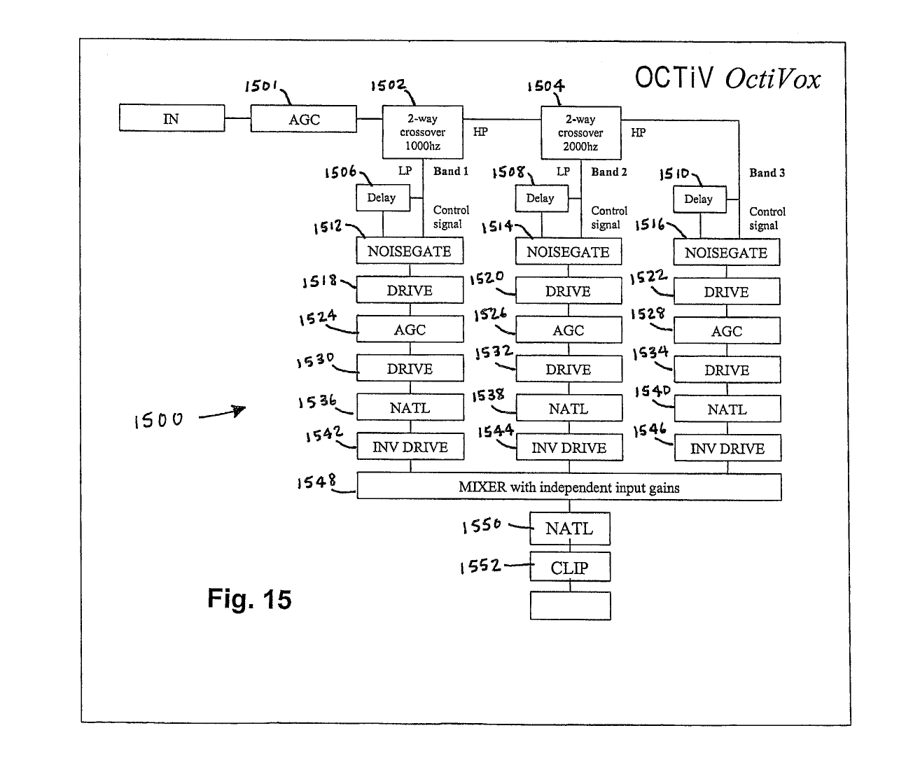

It will be understood that this idea may be further generalized to encompass the integration of a signal processor designed according to the invention into any electronic device or system which employs audio. This may include the types of devices discussed above, e.g., televisions, CD and MP3 players, car stereos, radios, etc. It may also include recording devices such as video and tape recorders, Mini Disc recorders, etc. The techniques of the invention may also be applied to any type of telephony or voice communication system whether over conventional telephone lines, the Internet, or in the wireless environment. An example of a multi-band processor for voice applications will now be described with reference to FIG. 15.

FIG. 15 shows a 3-band signal processor 1500 which may be employed, for example, in voice or telephony applications. The input audio is pre-processed by AGC 1501. The pre-processed audio is then divided into three frequency bands using 2-way crossover blocks 1502 and 1504 having cutoff frequencies of 1000 Hz and 2000 Hz, respectively. This may be accomplished, for example, as described above with reference to the multi-band crossover of FIG. 3. The samples in each of Bands 1-3 are then subjected to further processing as follows.

Noisegate blocks 1512-1516 remove components of the audio signal that are below a certain level of amplitude. Delay blocks 1518-1522 are used by noisegate blocks 1512-1516 for look-ahead/negative attack time. Drive blocks 1518-1522 represent user programmable gain adjustments which uniformly exaggerate the received signal component as it goes into the following AGC block (i.e., 1524-1528) which works to reduce changes in the gain. According to a specific embodiment, for every nth sample that doesn't overshoot its threshold, each of AGC blocks 1524-1528 incrementally increases its gain. Likewise, for every mth sample which does overshoot the threshold, each of AGC blocks 1524-1528 incrementally decreases the gain. According to various embodiments, the release function of AGC blocks 1524-1528 may correspond to any of the functions described above.

Drive blocks 1530-1534 are another set of user programmable gain adjustments which precede negative attack time limiters (NATLs) 1536-1540. For some signal transients which occur quickly, AGCs 1524-1528 may not react quickly enough and some overshooting samples would go otherwise go untreated resulting in a sharp overshoot at the beginning of the transient. To deal with this, NATLs 1536-1540 look at future samples and limit the gain of the current sample to avoid the distortion associated with such sharp overshoots. The lower the threshold is set, the more “dense” the sound becomes.

Each of drive blocks 1542-1546 is the inverse of the corresponding one of drive blocks 1530-1534, each of which works in concert with the corresponding one of inverse drive blocks to adjust the effective range of operation of the corresponding one of NATLs. Mixer block 1548 which has independently controllable gain for each band is followed by a final NATL 1550 which limits the total peak of the combined bands, e.g., constructive interference between peaks in different bands may cause peaks which need to be dealt with. NATL 1550 is followed by Clip block 1552 which removes any remaining overshoots from the signal.

The manner in which the signal processing techniques of the present invention facilitate the bandwidth reduction of an audio encoding scheme such as MP3 encoding relates to yet another set of embodiments. According to these embodiments, the benefits of the invention may be realized even without real-time application of the associated signal processing techniques to the digital audio. That is, any sequence of digital audio samples may be processed using a signal processor designed according to the present invention to generate audio files to be stored for playback at a later time.

For example, a provider of MP3 files to be downloaded over the Internet is not in a position to provide the same real-time processing as a provider of streaming audio. Nevertheless, the benefits of the present invention may be enjoyed by the provider and the user of such downloaded files even if the user does not have the signal processing capabilities of the present invention. That is, the provider of the MP3 files can apply the signal processing techniques of any of the embodiments of the present invention to any MP3 files, and then store the processed MP3 files for serving to users over the Internet. The files may then be downloaded and played using any of the available decoders/players, and the listening experience will be very much the same as if the processing techniques of the invention were being applied in real time. The preprocessing can be for any of the desired effects described above with reference to the various embodiments of the invention such as, for example, mitigating the undesirable artifacts of a low bit rate codec or providing a “signature” sound for the provider of the audio files.

Another example of a situation in which the benefits of the present invention may be enjoyed without the real-time processing of the audio samples is the production and distribution of recording media, e.g., compact discs, having audio files stored therein which have been preprocessed according to the present invention. That is, the manufacturer or distributor of audio CDs can preprocess the audio to be distributed on a CD for any of the purposes described above, e.g., providing a default sound for a particular type of music.

While the invention has been particularly shown and described with reference to specific embodiments thereof, it will be understood by those skilled in the art that changes in the form and details of the disclosed embodiments may be made without departing from the spirit or scope of the invention. That is, the basic building blocks of the specific configurations described, e.g., AGCs, negative attack time limiters, and drive blocks, may be combined in a wide variety of ways to provide highly efficient multi-band signal processing for a similarly wide variety of applications. Factors such as desired fidelity, available transmission bandwidth, and available processing overhead may interact to dictate different optimal configurations for different applications.

Additionally, various embodiments have been described herein with reference to implementation in software. However, it will be understood that the basic signal processing blocks of such embodiments may be implemented in other ways and remain within the scope of the invention. For example, these processing blocks may be implemented in application specific integrated circuits (ASICs) or programmable logic devices (PLDs). Hardware implementations of the processing blocks of the present invention are also possible.

Moreover, specific processor configurations have been described herein with reference to specific applications, e.g., streaming audio over the Internet, portable playback devices, set top boxes for cable and satellite television. It should be noted, however, that the configurations described above are not limited to corresponding applications. Rather, any of the described processors may be configured and deployed for any of a wide variety of applications including any of the applications described.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. At least one computer readable medium having computer program instructions stored therein for effecting multi-band processing of an original sampled signal, comprising:
first instructions for separating the original sampled signal into a plurality of signal components each corresponding to one of a plurality of frequency bands;
second instructions for independently and dynamically controlling a dynamic range associated with each one of the plurality of signal components;
third instructions for modifying at least one signal level associated with the plurality of signal components; and
fourth instructions for combining the signal components into a processed sampled signal.

2. The at least one computer readable medium of claim 1 wherein the first instructions separate the original sampled signal into one of 3, 4, and 5 overlapping frequency bands.

3. The at least one computer readable medium of claim 1 wherein the second instructions effect nonlinear control of a gain factor associated with each of the signal components.

4. The at least one computer readable medium of claim 1 wherein the second instructions control the dynamic range associated with each of the signal components by applying a gain factor to each sample of each of the signal components, the gain factor being dynamically adjusted.

5. The at least one computer readable medium of claim 4 wherein the gain factor for each of the signal components is dynamically adjusted every first number of samples.

6. The at least one computer readable medium of claim 5 wherein the first number comprises 64.

7. The at least one computer readable medium of claim 4 wherein the gain factor for each of the signal components is dynamically adjusted with reference to a threshold level to which each sample of each of the signal components is compared.

8. The at least one computer readable medium of claim 7 wherein the gain factor is adjusted upward using a release rate parameter where each sample is below the threshold level, and downward using an attack rate parameter where each sample is above the threshold level.

9. The at least one computer readable medium of claim 1 wherein the third instructions limit the at least one signal level with reference to a first number of future samples.

10. The at least one computer readable medium of claim 9 wherein a gain factor to be applied to a current sample is modified with reference to at least one of the future samples.

11. The at least one computer readable medium of claim 10 wherein the gain factor is decreased when application of the gain factor to the at least one future sample results in the at least one future sample exceeding a threshold, and wherein the gain factor is decreased after the gain factor has been applied to the first number of current samples.

12. The at least one computer readable medium of claim 1 wherein the third instructions implement an independent negative attack time limiter for application to each of the plurality of signal components.

13. The at least one computer readable medium of claim 1 wherein the third instructions implement a negative attack time limiter for application to the processed sampled signal.

14. The at least one computer readable medium of claim 1 further comprising fifth instructions for applying at least one preset gain factor to at least one of the processed sampled signal and the plurality of signal components.

15. The at least one computer readable medium of claim 14 wherein the at least one preset gain factor comprises a plurality of preset gain factors, each preset gain factor corresponding to one of the plurality of signal components.

16. The at least one computer readable medium of claim 15 wherein multiple ones of the plurality of preset gain factors correspond to each of the plurality of signal components.

17. The at least one computer readable medium of claim 16 wherein a first one of the multiple ones of the plurality of preset gain factors for a corresponding one of the plurality of signal components is an inverse of second one of the multiple ones of the plurality of preset gain factors for the corresponding one of the plurality of signal components.

18. The at least one computer readable medium of claim 17 wherein the first and second preset gain factors are applied to the corresponding signal component before and after, respectively, processing of the corresponding signal components by either of the second and third instructions.

19. The at least one computer readable medium of claim 14 wherein the at least one preset gain factor comprises a first preset gain factor for applying to the processed sampled signal.

20. The at least one computer readable medium of claim 1 wherein the first instructions implement at least one two-way crossover for separating the original sampled signal into the plurality of signal components.

21. The at least one computer readable medium of claim 1 wherein the first instructions implement at least one three-way crossover for separating the original sampled signal into the plurality of signal components.

22. The at least one computer readable medium of claim 1 wherein the first instructions correspond to four two-way crossover blocks for separating the original sampled signal into five signal components each corresponding to one of five frequency bands, wherein the second instructions correspond to five automatic gain control (AGC) blocks for independently and dynamically controlling the dynamic range associated with each one of the signal components, wherein the third instructions correspond to five negative attack time limiter (NATL) blocks for limiting the signal level associated with each of the signal components, the at least one computer readable medium further comprising fifth instructions for applying a predetermined gain to each of the signal components prior to processing by corresponding ones of the NATL blocks, and sixth instructions for applying an inverse of the predetermined gain to each of the signal components after processing by corresponding ones of the NATL blocks.

23. The at least one computer readable medium of claim 1 wherein the first instructions correspond to two three-way crossover blocks for separating the original sampled signal into five signal components each corresponding to one of five frequency bands, wherein the second instructions correspond to five automatic gain control (AGC) blocks for independently and dynamically controlling the dynamic range associated with each one of the signal components, and wherein the third instructions correspond to five negative attack time limiter (NATL) blocks for limiting the signal level associated with each of the signal components.

24. The at least one computer readable medium of claim 1 wherein the first instructions correspond to a two-way crossover block and a three-way crossover block for separating the original sampled signal into four signal components each corresponding to one of four frequency bands, wherein the second instructions correspond to four automatic gain control (AGC) blocks for independently and dynamically controlling the dynamic range associated with each one of the signal components, wherein the fourth instructions correspond to a mixing block for combining the signal components into a mixed sampled signal, and wherein the third instructions correspond to a negative attack time limiter (NATL) block for limiting a signal level associated with the mixed sampled signal.

25. A system for transmitting the processed sampled signal of claim 1 comprising the at least one computer readable medium of claim 1.

26. The system of claim 25 comprising a server platform in a wide area network.

27. The system of claim 25 comprising a digital radio transmission platform.

28. The system of claim 25 comprising a cellular communication system transmission platform.

29. The system of claim 25 comprising a cable television transmission platform.

30. The system of claim 25 comprising a satellite television transmission platform.

31. A system for receiving the original sampled signal of claim 1 comprising the at least one computer readable medium of claim 1.

32. The system of claim 31 comprising a client platform in a wide area network.

33. The system of claim 31 comprising a digital radio receiver.

34. The system of claim 31 comprising a portable cellular communication device.

35. The system of claim 31 comprising a cable television decoder.

36. The system of claim 31 comprising a satellite television decoder.

37. A portable device comprising the at least one computer readable medium of claim 1.

38. The portable device of claim 37 wherein the original sampled signal represents an audio signal and the portable device comprises a digital audio player.

39. The portable device of claim 38 wherein the digital audio player comprises a compact disc player.

40. The portable device of claim 38 wherein the digital audio player comprises an MP3 player.

41. A computer implemented method for effecting multi-band processing of an original sampled signal, comprising:
separating the original sampled signal into a plurality of signal components each corresponding to one of a plurality of frequency bands;
independently and dynamically controlling a dynamic range associated with each one of the plurality of signal components;
limiting at least one signal level associated with the plurality of signal components; and
combining the signal components into a processed sampled signal.

42. The computer implemented method of claim 41 as implemented in a wide area network having a server platform from which the original sampled signal originates and a client platform.

43. The computer implemented method of claim 42 wherein the separating, controlling, limiting, and combining occur on the server platform.

44. The computer implemented method of claim 42 wherein the separating, controlling, limiting, and combining occur on the client platform.

45. The computer implemented method of claim 41 further comprising encoding the processed sampled signal into a compressed file format.

46. The computer implemented method of claim 45 wherein the compressed file format is MP3.

47. A method for providing data files which comprise encoded versions of processed files resulting from the multi-band processing of claim 41.

48. The method of claim 47 wherein providing the data files comprises transmitting the data files in a wide area network.

49. The method of claim 47 wherein providing the data files comprises providing at least one computer readable medium having the data files stored therein.

50. The method of claim 47 wherein providing the data files comprises transmitting the data files using a transmitter of electromagnetic waves.

51. A computer readable medium having a data file stored therein representing the processed sampled signal generated using the computer implemented method of claim 41.

52. An apparatus for effecting multi-band processing of an original sampled signal, comprising:
means for separating the original sampled signal into a plurality of signal components each corresponding to one of a plurality of frequency bands;
means for independently and dynamically controlling a dynamic range associated with each one of the plurality of signal components;
means for limiting at least one signal level associated with the plurality of signal components; and
means for combining the signal components into a processed sampled signal.

53. A signal processor for effecting multi-band processing of an original sampled signal, comprising:
at least one first processing block for separating the original sampled signal into a plurality of signal components each corresponding to one of a plurality of frequency bands;
a plurality of second processing blocks for independently and dynamically controlling a dynamic range associated with each one of the plurality of signal components;
at least one third processing block for limiting at least one signal level associated with the plurality of signal components; and
at least one fourth processing block for combining the signal components into a processed sampled signal.

54. A signal processor for effecting multi-band processing of an original sampled signal, comprising:
four two-way crossover blocks for separating the original sampled signal into five signal components each corresponding to one of five frequency bands;
five automatic gain control (AGC) blocks for independently and dynamically controlling a dynamic range associated with each one of the signal components;
five negative attack time limiter (NATL) blocks for limiting a signal level associated with each of the signal components;
five first drive blocks for applying a predetermined gain to each of the signal components prior to processing by corresponding ones of the NATL blocks;
five second drive blocks for applying an inverse of the predetermined gain to each of the signal components after processing by corresponding ones of the NATL blocks; and
a mixing block for combining the signal components into a processed sampled signal.

55. A signal processor for effecting multi-band processing of an original sampled signal, comprising:
two three-way crossover blocks for separating the original sampled signal into five signal components each corresponding to one of five frequency bands;
five automatic gain control (AGC) blocks for independently and dynamically controlling a dynamic range associated with each one of the signal components;
five negative attack time limiter (NATL) blocks for limiting a signal level associated with each of the signal components; and
a mixing block for combining the signal components into a processed sampled signal.

56. A signal processor for effecting multi-band processing of an original sampled signal, comprising:
a two-way crossover block and a three-way crossover block for separating the original sampled signal into four signal components each corresponding to one of four frequency bands;
four automatic gain control (AGC) blocks for independently and dynamically controlling a dynamic range associated with each one of the signal components;
a mixing block for combining the signal components into a mixed sampled signal; and
a negative attack time limiter (NATL) block for limiting a signal level associated with the mixed sampled signal.

57. A signal processor for effecting multi-band processing of an original sampled signal, comprising:
two two-way crossover blocks for separating the original sampled signal into three signal components each corresponding to one of three frequency bands;
three automatic gain control (AGC) blocks for independently and dynamically controlling a dynamic range associated with each one of the signal components;
three negative attack time limiter (NATL) blocks for limiting a signal level associated with each of the signal components;
three first drive blocks for applying a predetermined gain to each of the signal components prior to processing by corresponding ones of the NATL blocks;
three second drive blocks for applying an inverse of the predetermined gain to each of the signal components after processing by corresponding ones of the NATL blocks; and
a mixing block for combining the signal components into a processed sampled signal.
